(19) United States
(12) Patent Application Publication
(10) Pub. No.: US 2010/0154717 A1
(43) Pub. Date: Jun. 24, 2010

(54) OXYGENATING IN AQUACULTURE

(76) Inventors: Karsten Glomset, Alesund (NO); Kenneth Glomset, Alesund (NO); Ove Gjelstenli, Vatne (NO); Per Rekkedal, Orsta (NO)

Correspondence Address: The BOC Group, Inc., 575 MOUNTAIN AVENUE, MURRAY HILL, NJ, 07974-2082, US

(21) Appl. No.: 12/639,435

(22) Filed: Dec. 16, 2009

(30) Foreign Application Priority Data
Dec. 19, 2008 (EP) 08022177.3

(51) Int. Cl. A01K 63/04; B01F 3/04; C02F 7/00

(52) U.S. Cl. 119/263; 261/77; 261/36.1; 261/37; 210/170.09

(57) ABSTRACT

The invention relates to a device for supplying gas into water in sea cages, tanks or ponds with a pump and a dissolver for contacting the gas with the water. For higher efficiency and better handling the pump is a submerged pump.

### BACKGROUND OF THE INVENTION

The present invention relates to a device for supplying gas into water in sea cages, tanks or ponds with a pump and a dissolver for contacting the gas with the water.

In aquaculture or at hatcheries it is important that the content of dissolved oxygen in the water is kept high. This is necessary for the health and the growing of the fishes. Because the solubility of gases in water is reduced by increasing the temperature while the oxygen need of the fish is increasing at high temperature, there is a particularly great need for oxygen in warm periods. Increasing the capacity of oxygen dissolvers is, therefore, highly useful for the fish farmer. In addition, most of the fish hatcheries produce more fish per liter water than the installation originally was dimensioned for. The amount of water is, therefore, the limiting factor of the installation. A better utilization of the water, a higher consumption of the oxygen and an improved dissolving capacity are therefore required.

Most hatcheries use pressurized oxygen dissolvers with a working pressure of 1-4 bars. By small amounts of water, it is normal to let all of the water flow go through the dissolver, but most commonly there is an outlet leading a part of the flow from the main pipe to a booster pump which pressurizes the dissolver. The oxygenated water is thereafter led back to the main pipe where it is mixed with untreated water. Most dissolving systems use 0-2. 5 kWh per kilo O₂ dissolved depending of efficiency. Injectors in combination with pressurized O₂ dissolvers are not common in Norway. The injectors which have been used have given a relatively small increase in the capacity, a great loss of pressure and increased consumption of energy.

US 2005/0275119A1 describes an oxygenating nozzle unit for the injection of gas in a liquid flow. The arrangement can for example be mounted on any pipe transporting liquid and with a need for the supply of gas, for example on the pipe supply to the basin for the farming of fish, on the pipe after circulation pump on a boat for live fish transportation, on the pipe after a circulation pump for vehicles for live fish transportation, on the pipe after a circulation pump on a container or other arrangement for live fish transportation or on pressurized dissolvers for increasing the oxygenating capacity. The known venturi system generates micro bubbles in the water. By the means of gas diffusion and redistribution of dissolved gas components in water one can dissolve and add gas at a very low pressure, preferred for sea water applications.

### BRIEF SUMMARY OF THE INVENTION

It's an object of the invention to increase the oxygen level in the water. A second object is to ease the handling and the installation or removal when needed.

These objects are solved by a device with the features of claim 1. The depending claims disclose embodiments of the invention.

The invention proposes the use of a submerged pump. By making an installation where we combine common dissolvers like the SOLVOX-A or a venturi dissolver with a submerged pump and an outlet device, we can oxygenate the water in sea cages, tanks or ponds in a very easy and effective way. The inventive device is suitable for a lot of gases to be dissolved in a lot of different liquids, but preferred is the application of dissolving oxygen in water. Oxygen means pure oxygen, technical pure oxygen (90-96% O₂) or oxygen enriched air (oxygen content of >20%). The oxygen can be stored in bottles, bundles or tanks, possible under pressure or in liquid state. In the latter case an evaporator is commonly used. The oxygen can be delivered to the dissolver by a flexible hose or tube.

All types of pumps can be used, which are able to move or pump a liquid like water. Preferred is the use of an electrical or a mechanical driven pump. Immersion pumps with a sealed electric motor and a rotating element (centrifugal pump) are common knowledge and widely used in sewing lifting installations. Piston pumps are also applicable. For industrial aquaculture use the power input should be greater than 100 Watt. More preferred are pumps with more than 300 W, also in the region of 0.5 or 1 kW or some kW power consumption. Rough power oxygen proportion is 1:10 (1 kW brings in 10 kg oxygen). Electric driven mechanical pumps with pistons or blades are better suited than Löscher pumps. The pump preferably sucks directly water from the tank wherein it is immerged. This saves an intake line or equivalent installations. The idea of the invention is to distribute oxygenated water instead of pure oxygen gas bubbles directly into the sea cage, tank or pond.

In a preferred embodiment the pump and the dissolver (and if desired the outlet) are in direct contact which leads to a submergible, watertight unit. The unit can be made by bolting together flanged elements or by combining the elements into one sealed housing. With this invention it is possible to
Get satisfactory oxygen levels in sea cages, tanks or ponds.
Create satisfactory oxygen levels where needed in the sea cages, tanks or ponds.
Help handle the fish inside the sea cage/tank when e.g. emptying the cages, tanks or ponds.
Create a plug and play solution, easy to handle, to install or remove in a sea cage tank or pond when needed and where needed.
Supply oxygen and water movement during parasite treatment or vaccination.
Reduce waste of fish feed at elevated oxygen levels.
Reduce stress and mortality on fish and shellfish at elevated oxygen levels.
Increase fish welfare and generally reduce problems with fish health/decease.
Reduce environmental pollution caused by better conversion of feed to flesh at elevated oxygen levels.
Increase growth rate on fish and shellfish.
Give the user a more easy handle and controllable oxygenating system with high capacity.
Help the user to easy control the fish inside the sea cages, tanks or ponds.

The invention helps to eliminate the following problems on existing technology:
Low oxygen level in sea cage, tank or ponds.
Loss of oxygen caused by oxygenating areas with no fish.
Low dissolved oxygen situations during vaccination or parasite treatment.

The invention shows following advantages:
Increased oxygen level
Reduced mortality of fish
Introduction of oxygen in a mixture of oxygen and water
Higher efficiency
Easier handling.

Some methods for introducing oxygen into water, distributes “pure” oxygen bubbles directly into the fish basin (diffusers). If it is negative for fish to be in direct contact with “pure” oxygen bubbles, in terms of possible reduction of slime layer and/or burning of gill filaments, this new invention will differentiate from that as this solution introduces oxygen enriched water instead of the “pure” gas bubbles directly.

In a preferred embodiment the water outlet is a nozzle. With this nozzle it is possible to move the fish to desired spots in the sea cage, tank or pond by moving the nozzle in different directions. The fish is gathered in front of the invention so that the fish is easier to suck into a vacuum fish pump. Possible is increased oxygen content in fish transport hoses from the cage/tank to the processing plant. The invention is easy to handle and to mount or remove in a sea cage, tank or pond when needed.

The water outlet of the invention can also be a perforated hose, a tube with holes or any equivalent component, which distributes the oxygenated water under slight overpressure in the cage in a desired distribution.

In a preferred embodiment the submerged unit has on his top an eye or a hook or a hanger for hanging the device on a rope or a chain and submerging it easy into the cage to a desired position.

The invention can be manufactured from various materials. Preferably it is made from non-corrosive materials such as plastics, polypropylene or polyvinyl chloride.

Areas of application can be in all situations where water needs to be added oxygen in a tank/pool/basin preferably in breeding of fish or other organisms living in water (e.g. shrimps, mussels, crabs, lobsters or shellfish). The normal temperature range where the invention can be used is in the range between 0-30° C.; the invention is made to operate completely submerged.

### BRIEF DESCRIPTION OF THE DRAWINGS

The invention will be described in more detail by the use of some drawings.

FIG. 1 to FIG. 4 show some embodiments of an inventive device.

FIGS. 5 and 6 show two inventive devices arranged in sea cages.

### DETAILED DESCRIPTION OF THE INVENTION

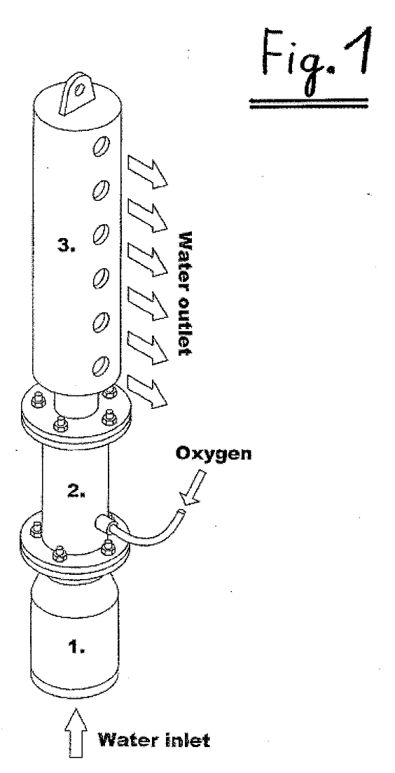

FIG. 1 shows an inventive device consisting of a water pump 1, a dissolver 2 and a water outlet 3, which here is designed as a tube with holes. All three elements 1, 2, 3 are combined with flanges with one another and can so be mounted and dismounted very easily. On the top of the water outlet 3 there is an eye for hooking the unit. The water is sucked in at the bottom (water inlet); the water outlet is at the top and in this embodiment directed in a horizontal direction. The oxygen is fed with a flexible hose or pipe to the dissolver 2. Not shown is an electrical cable for feeding the electrical pump 1.

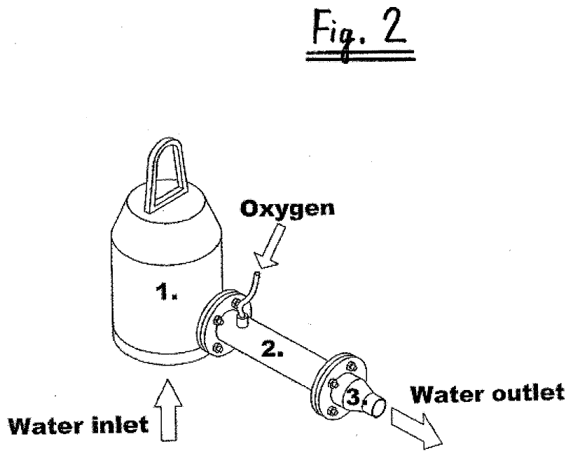

FIG. 2 shows another embodiment of an inventive device. The pump 1, the dissolver 2 and the water outlet 3 are mounted by flanges together to one unit. In this embodiment the water outlet is a nozzle which directs a water jet in a horizontal direction.

Both FIGS. 1 and 2 are made to both oxygenate and create a current. One of the advantages of both embodiments is that one can get the fish inside the sea cage/tank to move against the current created by the water outlet nozzle. This makes it possible to easy handle the fish when emptying the sea cage, tank or pond. The fish will try to go upstream of the current created by the nozzle and will, therefore, get the best environment regarding oxygen levels and water quality. This can be a huge advantage especially in holding cages/tanks at the harvesting plants where one wants the fish to move to where it can be taken out of the cages or tanks.

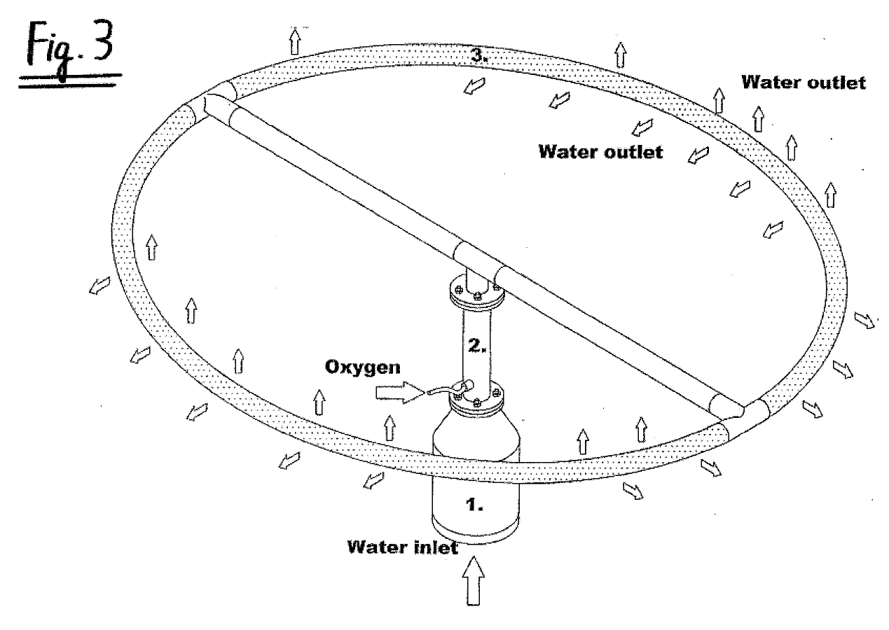

FIG. 3 shows another embodiment of this invention, where the pump 1 and the dissolver 2 are the same as in FIG. 1. The water outlet 3 is here made as an oxygen dissolver consisting of a perforated hose which is arranged in a circular way to have a very wide field of distribution of oxygen in any direction. The oxygenated water can be dissolved in horizontal and vertical directions.

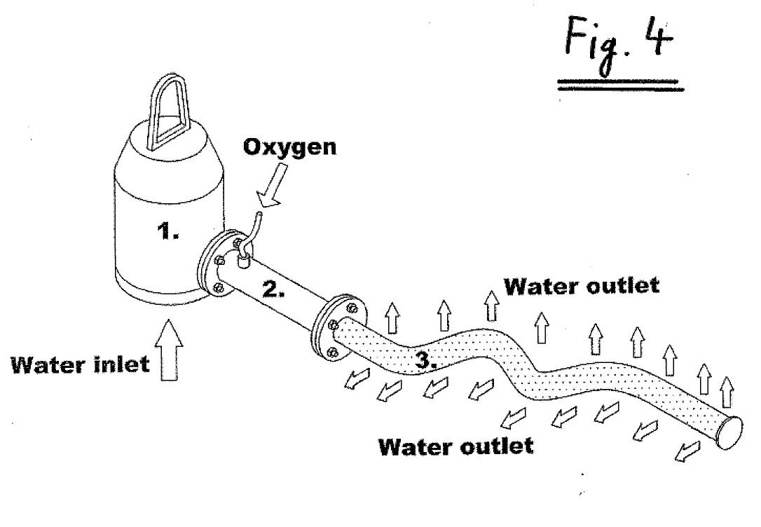

FIG. 4 shows another embodiment of an inventive device, where the water outlet 3 is a flexible hose which is floating in the cage at desired depth. The embodiments of FIGS. 3 and 4 are more focused on dissolving oxygen at low pressure and low energy costs. This is used in cages, tanks or ponds where the main goal is to create satisfactory oxygen levels and not creating current. These embodiments are mainly considered useful when satisfactory oxygen levels at all times during ongoing production cycles or in special situations as vaccination or parasite treatment are desired.

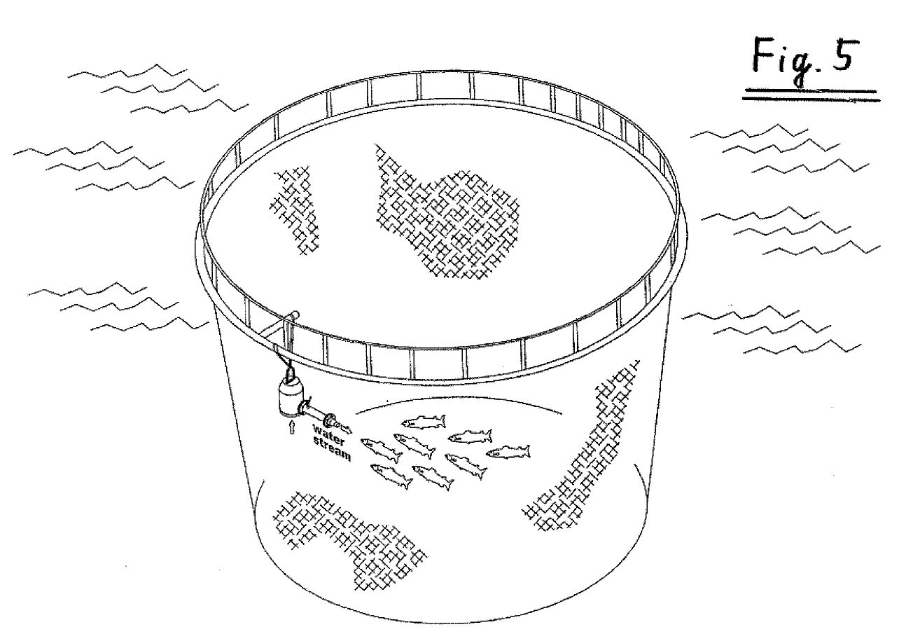

FIG. 5 shows an embodiment of the invention arranged in an open sea cage. The embodiment is hanging on a rope on the inside of a sea cage. The current originated by the nozzle of the water outlet leads to a water flow where the oxygen level is very high. The fishes seek to orient themselves to this very good oxygenated water with desired current. This enhances the efficiency of the device. The invention can also be oriented outside the sea cage, then blowing oxygenated water into the cage. It can be situated horizontally or vertically as desired to orient the fish where wanted.

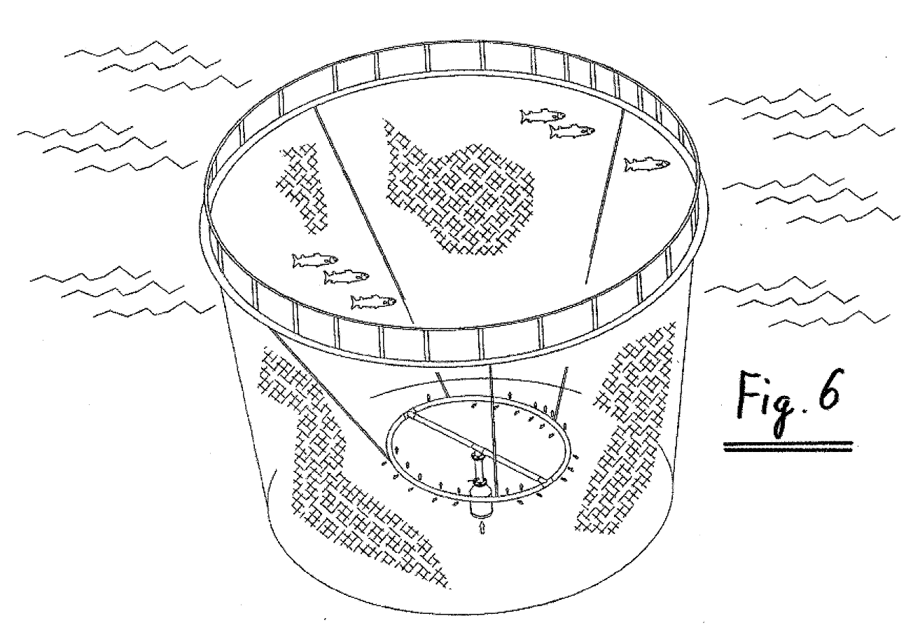

FIG. 6 shows an embodiment where the oxygenating device of FIG. 4 is arranged in a sea water cage with ropes, chains or wires. The arrangement is near the bottom of the sea cage and oxygenates the sea water within a very wide region.

An example for the embodiment of FIG. 2:
Flow 1000 litres/min through the system.
Needed pressure is 0.2 bar.
Introduction of 10 kg O2 per hour.
Power needed 0.5 KW energy. (see calculation below)
Power vs oxygen ratio 0.5:10
1000 l/min/60 min/sec=16.66 litres/sec×2 metres/102 (constant)=0.33 KW 0.33 KW/0.65 (65% efficiency of the pump)=0.50 KW needed.

1. An apparatus for supplying gas into water in sea cages, tanks or ponds comprising a pump, a dissolver and a water outlet wherein the pump is a submerged pump.

2. The apparatus of claim 1 wherein the gas is oxygen or oxygen enriched air.

3. The apparatus of claim 1 wherein the pump is an electrical pump or a mechanical pump.

4. The apparatus of claim 1 wherein the pump pumps water directly from the cage, tank or pond.

5. The apparatus of claim 1 wherein the pump pumps water from a location external to the cage, tank or pond.

6. The apparatus of claim 1 wherein the pump and the dissolver are directly connected to form a submergible unit.

7. The apparatus of claim 1 wherein the water outlet is a nozzle, a perforated hose or a tube with holes.

8. The apparatus of claim 1 further comprising a hook, eye or other mechanical construction, that is fixed or adjustable to allow for hanging of the apparatus.
